(19) United States
(12) Patent Application Publication
(10) Pub. No.: US 2014/0136125 A1
(43) Pub. Date: May 15, 2014

(54) SYSTEM AND METHOD FOR MULTI-PHASE FLUID MEASUREMENT

(71) Applicant: Agar Corporation Ltd., Grand Cayman (KY)

(72) Inventors: Joram AGAR, Grand Cayman (KY); Vikram SIDDAVARAM, Cypress, TX (US)

(73) Assignee: Agar Corporation Ltd., Grand Cayman (KY)

(21) Appl. No.: 13/864,007

(22) Filed: Apr. 16, 2013

Related U.S. Application Data
(63) Continuation-in-part of application No. 12/773,663, filed on May 4, 2010, now Pat. No. 8,521,436.

(51) Int. Cl. G01F 7/00

(52) U.S. Cl. CPC G01F 7/00
USPC 702/45

(57) ABSTRACT

The flow meter system includes flow meters taking measurements based on a set of parameters of a multiphase fluid, each measurement corresponding to respective groups of interrelated unknown variables. These unknown variables are selected from the set of parameters, and the groups of unknown variables are different from each other. A processor uses an iterative process to solve equations of a mathematical model, determined by the equations corresponding to the measurements and groups of unknown variables, so as to estimate an amount of a target unknown variable selected from the set of parameters. The method for estimating a target unknown variable of a multiphase fluid includes installing flow meters in the multiphase fluid; taking measurements based on a set of parameters; determining a mathematical model with equations corresponding to the measurements and groups of interrelated unknown variables; and solving equations with an iterative process.

### RELATED U.S. APPLICATIONS

The present application is a continuation-in-part application under 35 U.S. Code Section 120 of U.S. application Serial No. 12,773,663, filed on May 4, 2010, and entitled “MULTI-PHASE FLUID MEASUREMENT APPARATUS AND METHOD”, presently pending.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

Embodiments of the present invention generally relate to multi-phase flow measurements of wellbore fluids. In particular, a system and method of identifying and characterizing a multi-phase fluid are disclosed.

2. Description of Related Art Including Information Disclosed Under 37 CFR 1.97 and 37 CFR 1.98.

Wellbore fluids often are multi-phase fluids that contain oil, gas and water. The amount and mixture of these components can vary in a wellbore fluid, so that the wellbore fluid is difficult to characterize and identify. The properties, such as composition, flow rate, and viscosity of each component (oil, water, and gas), vary from well to well.

For example, flow rate of a multi-phase fluid is difficult to measure because, usually, the flow rate of the gas is the fastest and that of the oil the slowest, unless the fluid is well-mixed and gas is entrained inside the liquid. Also, flow patterns affect measurements. The large variety of flow patterns in which the liquid and gas might be distributed and the variations in the physical properties of each component make flow rate prediction of each component difficult. The orientation of the flow is also quite important. In vertical tubings or risers, the effects of buoyancy resulting from the large density differences between the gas and liquid cause the gas to rise much faster than the liquid or in other words, increase the slip between the gas and liquid. Similarly, at low fluid velocities, wellbore liquids tend to accumulate at low pockets in horizontal pipes while gas coalesces into large and small bubbles, which propagate faster than the liquid, thereby increasing the slip between gas and liquid.

Fluid density is a parameter used for determining the flow of multi-phase fluids. Some methods utilize spot density, which is the density at a particular cross-section of the flow conduit, over a very narrow (compared to the hydraulic diameter) length of the conduit. Spot density may be different from the homogeneous mixture density due to the slip between the gas and liquid in the multiphase fluid.

In the flow rate example, mathematical models have been used for computing multi-phase fluid flow. Such methods, however, require rigorous knowledge of the boundary conditions of multiple parameters, such as surface tension, viscosity, fluid mixture, etc., all of which influence the slip. As such parameters are not being measured in line (in-situ); the value of slip is assumed or obtained from certain empirical experiments. This assumption confines the validity of the mathematical model to the specific assumptions made or to the conditions under which the experiments were conducted, e.g. diameter of the pipe, orientation of the flow, choice of multiphase fluid components etc. The slip value in the multiphase fluid produced from a wellbore is sometimes different from such experimentally determined slip values, and thus large errors can result.

In one particular flow rate example, showing the effects of orientation and flow pattern, FIGS. 1a and 1b illustrate two typical flow regimes in horizontal and vertical pipe flows respectively. If the inclination of the horizontal pipe is changed slightly to +15° upward or −15° downward, the flow pattern will be completely different from what is shown. Similarly, the flow pattern for an inclination of 5° will be different from that for an inclination of 15°, 11°, etc. and therefore the resulting slip values will be completely different. Since there is a huge variety of piping configurations and fluid parameter values, using empirically determined slip values will lead to large errors.

The impact of slip and flow pattern is illustrated by the following example, shown in FIGS. 1c and 1d. The figure shows two fluid streams, one composed of oil of density P_{Oil}=800 kg/m³ and viscosity μ_{Oil}=100 cP flowing at a flow rate Q_{Oil}=1000 m³/d and the other composed entirely of water of density ρ_{Water}=1000 kg/m³ and viscosity μ_{Water}=1 cP flowing at a flow rate Q_{Water}=1000 m³/d. The two fluid streams are flowing thru two identical pipes, commingle in a bigger pipe and eventually flow into an (initially empty) tank where they separate due to gravity. As the flow rates of the oil, Q_{Oil} and water, Q_{Water} are the same, the volume of oil, V_{Oil} and water, V_{Water} in the tank are the same. This statement follows from the conservation of mass.

However, in the bigger pipe where the two fluid streams commingle, the density measured depends on the flow pattern. For example, when the flow rates of oil and water are high, the two flow streams would be well-mixed and the resulting flow pattern is as shown in FIG. 1c. In this case, the mixture is homogeneous (slip=1), with a mixture density, ρₘᵢₓ. Since the mixture is homogeneous, the mixture density is,

$${ρ}_{mix} = \frac{{ρ}_{Oil} * {Q}_{Oil} + {ρ}_{Water} * {Q}_{Water}}{( {Q}_{Oil} + {Q}_{Water} )}$$

### Since, Q_{Oil}=Q_{Water}

$${ρ}_{mix} = \frac{{ρ}_{Oil} + {ρ}_{Water}}{2} = 900 kg / {m}^{3}$$

Now, when the flow rates are small, there will be stratified flow, as shown in FIG. 1d. The differential pressure measured on the oil side is given by the relation:

$$Δ {P}_{oil} = \frac{8 {πμ}_{Oil} {LQ}_{Oil}}{{A}_{Oil}^{2}}$$

Similarly, the differential pressure measured on the water side is given by the relation:

$$Δ {P}_{Water} = \frac{8 {πμ}_{Water} {LQ}_{Water}}{{A}_{Water}^{2}}$$

In the above equation, A_{Oil} is the area of the big pipe occupied by oil and A_{Water} is the area of the big pipe occupied by water.
Since, ΔP_{Water}=ΔP_{Oil}, we have

$$\frac{{A}_{Water}}{{A}_{Oil}} = {( \frac{{μ}_{Water}}{{μ}_{Oil}} )}^{0.5}$$

Since μ_{Water}=1 cP and μ_{Oil}=100 cP, the area occupied by oil is 10 times that of water and therefore the average velocity of water is 10 times that of oil (since Q_{Oil}=Q_{Water}). Therefore, the density of the mixture is now:

$${ρ}_{mix} = \frac{{ρ}_{Oil} * {A}_{Oil} + {ρ}_{Water} * {A}_{Water}}{{A}_{Pipe}} \approx 820 kg \text{/} {m}^{3}$$

Thus, it can be seen that the mixture density for FIG. 1d (stratified flow) is different from that for FIG. 1c (homogeneous flow). Interfacial tension can affect the flow patterns as well, leading to, for example, wavy flow and slug flow, which can result in different values of mixture density. Thus the true determination of mixture density (and other mixture properties) requires that slip and flow pattern be properly determined. Even with these complexities (slip and flow pattern, and others) of a multiphase fluid, prior art systems have still determined flow rates of the components of multiphase fluid based on full non-linear partial differential equations. In theory, these known equations are solved for a mathematically rigorous determination of the multiphase component flow rates. The equations are given below are examples:

Conservation of mass:

$$\frac{\partial }{\partial t} ( {ρ}_{N} {α}_{N} ) + \frac{\partial ( {ρ}_{N} {j}_{Ni} )}{\partial {x}_{i}} = {I}_{N} \qquad Eqn . 1$$

Conservation of momentum:

$$\frac{\partial }{\partial t} ( {ρ}_{N} {α}_{N} {u}_{Nk} ) + \frac{\partial }{\partial {x}_{i}} ( {ρ}_{N} {α}_{N} {u}_{Ni} {u}_{Nk} ) = {α}_{N} {ρ}_{N} {g}_{k} + {F}_{Nk} - {δ}_{N} \{ \frac{\partial p}{\partial {x}_{k}} - \frac{\partial {σ}_{CKi}^{D}}{\partial {x}_{i}} \} \qquad Eqn . 2$$

Conservation of energy

$$\frac{\partial }{\partial t} ( {ρ}_{N} {α}_{N} {e}_{N}^{*} ) + \frac{\partial }{\partial {x}_{i}} ( {ρ}_{N} {α}_{N} {e}_{N}^{*} {u}_{Ni} ) = {Q}_{N} + {W}_{N} + {E}_{N} + {δ}_{N} \frac{\partial }{\partial {x}_{k}} ( {u}_{Ci} {σ}_{Cij} ) \qquad Eqn . 3$$

In the above equations, the subscript N denotes a specific phase or component, which in the case of wellbore fluid may be oil (0), water (W) and gas (G). The lower case subscripts (i, ik, etc.) refer to vector or tensor components. The tensor notation is followed where a repeated lower case subscript implies summation over all of its possible values, e.g.

uᵢuᵢ=u₁u₁+u₂u₂+u₃u₃ Eqn. 4

ρ_{N} is the density of component N, α_{N} is the volume fraction of component N, and j_{Ni} is the volumetric flux (volume flow per unit area) of component N, where i is 1, 2, or 3 respectively for one-dimensional, two-dimensional or three-dimensional flow. I_{N} results from the interaction of different components in the multiphase flow. I_{N} is the rate of transfer of mass to the phase N, from the other phases per unit volume. u_{Nk} is the velocity of component N along direction k. The volumetric flux of a component N and its velocity are related by:

j_{Nk}=α_{N}u_{Nk} Eqn. 5

gₖ is the direction of gravity along direction k, p is the pressure, σ_{Cki}^{D} is the deviatoric component of the stress tensor σ_{Cki} acting on the continuous phase, F_{Nk} is the force per unit volume imposed on component N by other components within the control volume.

e*_{N} is total internal energy per unit mass of the component N. Therefore,

e*_{N}=e_{N}+ 1/2u_{Ni}u_{Ni}+gz Eqn. 6

where e_{N} is the internal energy of component N. Q_{N} is the rate of heat addition to component N from outside the control volume, W_{N} is the rate of work done to N by the exterior surroundings, and E_{N} is the energy interaction term, i.e. the sum of the rates of heat transfer and work done to N by other components within the control volume.

The above equations are subject to the following constraints:

$$\begin{matrix}{\sum }_{N} {I}_{N} = 0 & Eqn . 7 \\ {\sum }_{N} {F}_{Nk} = 0 & Eqn . 8 \\ {\sum }_{N} {E}_{N} = 0 & Eqn . 9\end{matrix}$$

The above equations are a system of nonlinear partial differential equations, for solving the individual component flow rates. Naturally, the solution to such equations depends on the imposed initial and boundary conditions, which determine the values for all of the variables in the equations. The initial conditions, such as initial distribution of the component phases, are not always known apriori. The boundary conditions, such as the flow pattern and the size distribution of the bubbles, are also not known in advance. In the prior art, estimations are used for some of these variables, instead of actual determined values. Those estimations introduce lack of precision and accuracy in the values calculated from the equations. In addition, it can be seen that the exact mathematical solution depends on even more parameters which take into account the interaction between the components. These interaction parameters are also not known apriori. In light of the above discussion, it can be seen that the exact mathematical solution to the above system of partial differential equations is not possible for any but the most simple cases. Prior art systems and method accept this degree of error and inaccuracy.

### SUMMARY OF THE INVENTION

Embodiments of the present invention include a flow meter system comprising an m number of flow meters taking n measurements based on a set of parameters of the multiphase fluid, wherein m is a positive integer, and wherein n is a positive integer. The n measurements correspond to respective n groups of interrelated unknown variables. The unknown variables are selected from the set of parameters, such as density, flow and slip, and the n groups of interrelated unknown variables are different from each other in terms of number of interrelated unknown variables, identity of interrelated unknown variables or both. The interrelatedness of the unknown variables is based on the mathematical compatibility for a converging solution. The invention also includes a processor to solve equations of an iterative mathematical model so as to estimate an amount of a target unknown variable selected from the set of parameters. The n measurements of the m flow meters and the n groups of interrelated unknown variables are selected because of their compatibility in this iterative mathematical process as a whole. The n measurements and the n groups of interrelated unknown variables contribute equations to the mathematical model, which allows for the solution of the target unknown variable with a higher degree of precision and accuracy, such that the estimation of this value by the present invention is more reliable than the prior art systems and methods, which substitute assumed values for unknown variables.

Embodiments of the present also include a method for estimating a target unknown variable of a multiphase fluid. One embodiment of the method includes: installing an m number of flow meters along a fluid flow of the multiphase fluid, wherein m is a positive integer, and wherein n is a positive integer; taking n measurements by the flow meters based on a set of parameters of the multiphase fluid, each of n measurements corresponding to a respective n groups of interrelated unknown variables; determining a mathematical model compatible with an iterative process and comprised of equations corresponding to each of the n measurements of the m flow meters; and solving the equations with the iterative process for a more accurate and precise value of the target unknown variable. The unknown variables are selected from the set of parameters, and the n groups of interrelated unknown variables are different from each other. The n groups of interrelated unknown variables can be different in number, identity, both or other grounds to result in a different equation to contribute to the system. Because the n groups of interrelated unknown variables are different from each other in the equations based on the n measurements, the equations are different from each other and contribute to the iterative mathematical model.

In embodiments of the system and method, each group of interrelated unknown variables is different, and the target unknown variable is selected from an unknown variable of the n groups of interrelated unknown variables corresponding to the n measurements. Each group of interrelated unknown variables is different, in terms of number of unknown variables, identity of unknown variables, both number and identity or other grounds in order to contribute to the iterative mathematical model. The target unknown variable can be solved by the selected measurements because the target unknown variable is selected from the group of interrelated unknown variables. The system and the method include selecting a number of equations of the mathematical model so as to correspond to a number of interrelated unknown variables of the n groups of unknown variables, according to compatibility with the iterative process. This number of equations is determined by a number of measurements from the m flow meters, a number of the m flow meters, types of flow meters, sensitivity of a flow meter to a measured variable or any combination of these factors.

The present invention selects for an m flow meter taking an n measurement because of the resulting compatible equation, which is interactive with and determined by the other flow meters and their respective compatible equations. As a whole, a system and method of m flow meters and a processor of the present invention is inter-dependent and selected, unlike prior art systems with multiple meters. The results are not just compiled, and the math is not adjusted to account for merely adding another flow meter. The embodiments of the present invention disclose a system and method of selected numbers and types of flow meters contributing to an iterative mathematical model for the more accurate estimation of a target unknown. A particular flow meter can only be added because of criteria set by compatibility of the flow meters already in the system of the present invention. The number of flow meters, the type of flow meters, and the sensitivity of flow meters, the order of flow meters, all interact and can adjust according to the disclosures of the present application, unlike any prior art system.

### BRIEF DESCRIPTION OF THE DRAWINGS

For detailed understanding of the present disclosure, references should be made to the following detailed description, taken in conjunction with the accompanying drawings in which like elements have generally been designated with like numerals.

FIG. 1a is a schematic view, illustrating wavy-annular flow in a horizontal pipe.

FIG. 1 b is another schematic view, illustrating churn flow in a vertical pipe.

FIG. 1 c is a schematic view, illustrating effects of slip and flow pattern on high flow rate.

FIG. 1 d is a schematic view, illustrating effects of slip and flow pattern on low flow rate.

FIG. 1 e is a schematic view, illustrating a simplified embodiment of the invention with three unknown variables.

FIG. 1f is a schematic view, illustrating a more complex embodiment relative to FIG. 1e with another flow meter.

FIG. 1g is a schematic diagram of a multi-phase flow meter apparatus according to one embodiment of the disclosure.

FIG. 2 is flow diagram of a method of determining multi-phase flow.

FIG. 3 is a schematic diagram of an apparatus for determining density by a density meter, such as vibrating fork, tubes and cylinders, floats and the like, for use in the method of determining flow of a multi-phase fluid.

FIG. 4 is a schematic diagram showing an alternative flow meter, such as orifice plates, inverted cones, turbine flow meters, ultrasonic flow meters, positive displacement meters, and the like instead of the venturi meter indicated in FIG. 1g.

FIG. 5 is a schematic diagram of an alternative embodiment of an apparatus for measuring the flow rate, e.g. in wet-gas measurement.

FIG. 6 is a functional diagram of an exemplary computer system configured for use with the system of FIG. 1g.

FIG. 7a shows a plot of density deviation versus gas volume fraction, as described in equation 19.

FIG. 7b shows a plot of the bulk density of the mixture, after correcting for the effect of slip, using equations 10 & 12, which shows that the gas volume fraction range of operation is from zero to one hundred percent.

### DETAILED DESCRIPTION OF THE DRAWINGS

An embodiment of the present invention includes a flow meter system comprising an m number of flow meters taking n measurements based on a set of parameters of the multiphase fluid, each of n measurements corresponding to a respective n groups of interrelated unknown variables, wherein m is a positive integer and wherein n is a positive integer. The interrelated unknown variables are selected from the set of parameters, and the n groups of interrelated unknown variables are different from each other in terms of number of interrelated unknown variables, identity of interrelated unknown variables or both. The invention also includes a processor to solve equations of a mathematical model so as to estimate an amount of a target unknown variable selected from the set of parameters. The n measurements of the m flow meters and the n groups of interrelated unknown variables are selected because of their compatibility in an iterative mathematical process. The n measurements and the n groups of interrelated unknown variables determine the equations of the mathematical model, wherein an iterative process is used to solve the equations. The target unknown variable is now known to a higher degree of accuracy, such that the estimation of this value is more precise and more accurate than the prior art systems and methods, which substitute assumed values for unknown variables.

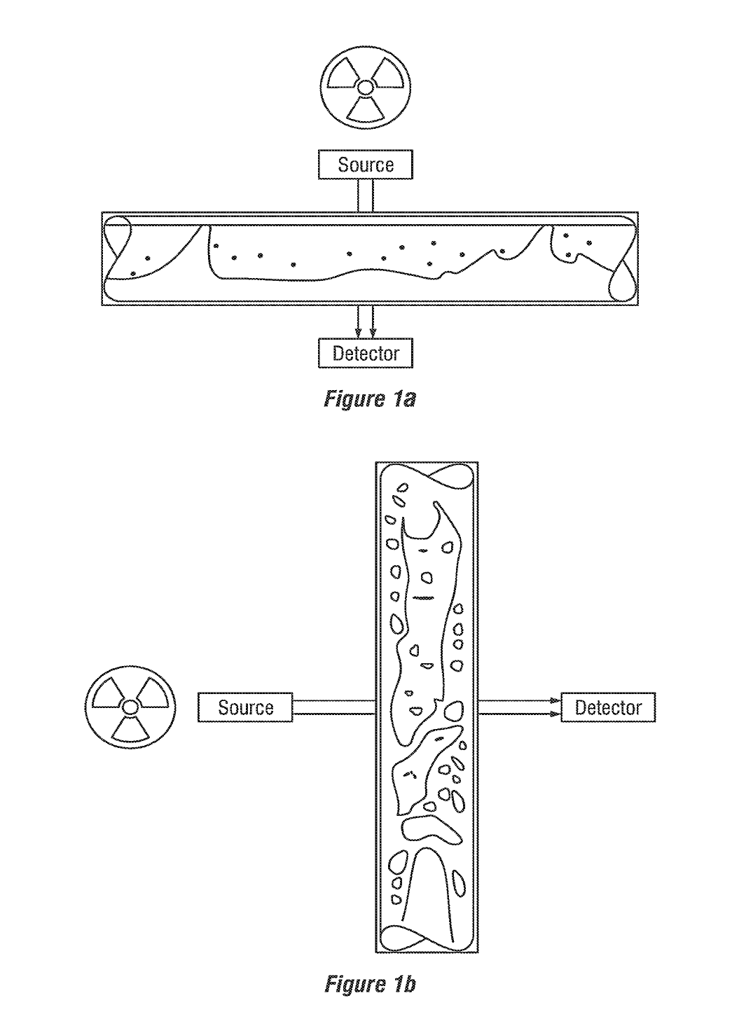

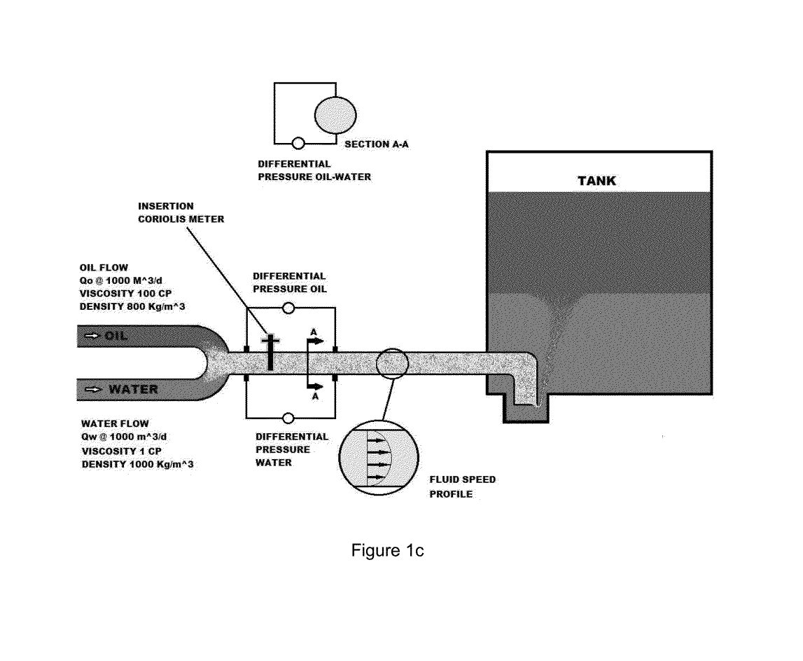

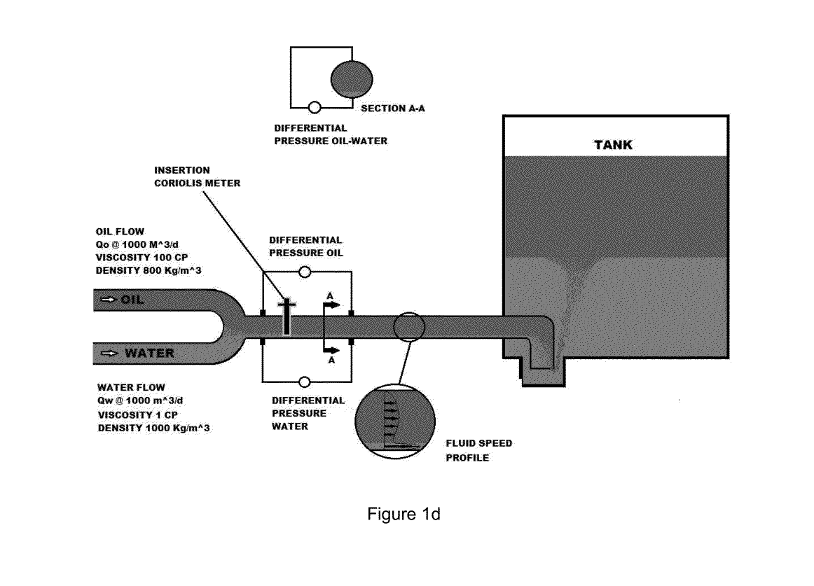

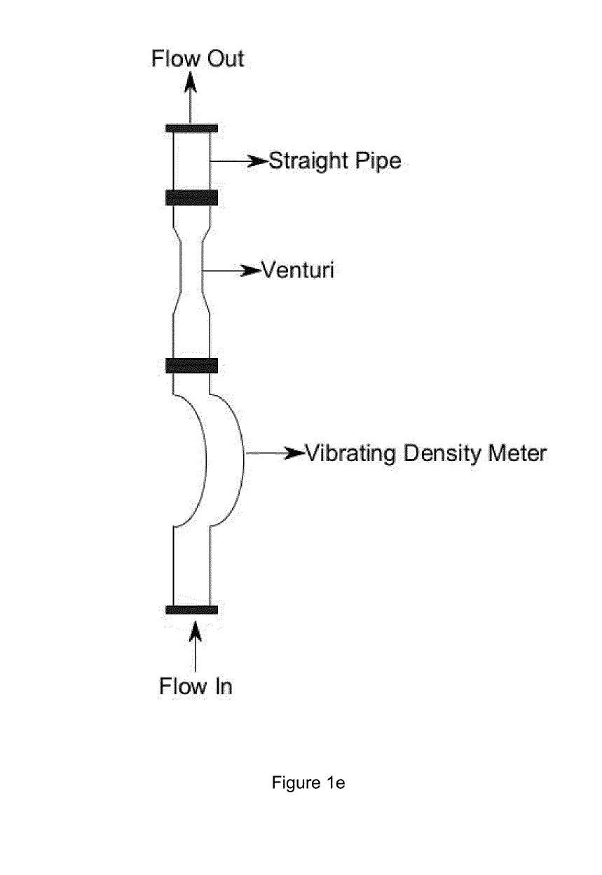

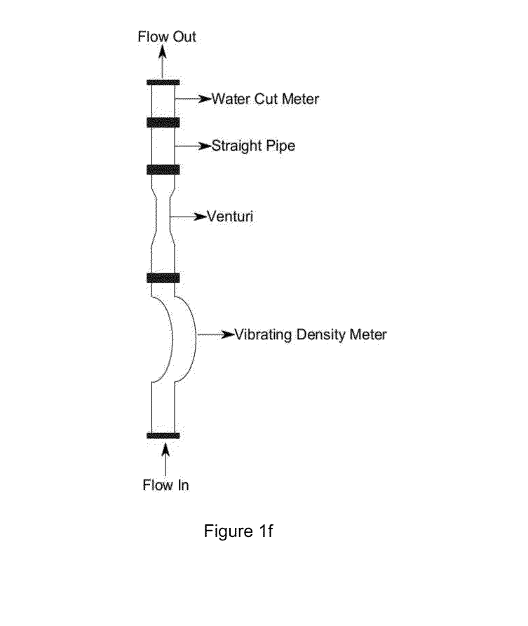

The term “flow meter” is used to define a meter placed along the flow of the multiphase fluid. As such, the “flow meter,” as used in present application and claims, covers both devices which measure aspects and characteristics of flow, such as density and viscosity, and devices which can be affected by flow when taking measurements without measuring any aspect of flow. For example, the third flow meter in FIG. 1g is a water cut meter, which does not measure any aspect or characteristic of flow of the multiphase fluid; but rather, the water cut meter measures dielectric constant of the multiphase fluid. This dielectric constant can be affected by flow, but dielectric constant is not an actual measurement of flow. The water cut meter is still a possible third flow meter as now claimed and described in the application because the water cut meter is a measuring device placed along the flow of the multiphase fluid.

Each group of interrelated unknown variables is different, in terms of number of interrelated unknown variables, identity of interrelated unknown variables, both number and identity or other grounds. Each n measurement corresponds to a different group of interrelated unknown variables, so that equations determined by the n measurements are compatible in an iterative mathematical solution. That is, the target unknown variable can be solved by the selected measurements. The target unknown variable is selected from an unknown variable of the n groups of interrelated unknown variables corresponding to the n measurements, and the iterative process solves for the target unknown variable. The term “interrelated” is used to describe the unknown variables. The unknown variables must be interrelated in order to be compatible to the iterative process of the present invention. The iterative process of the present invention requires the solution to converge, which means that the unknown variables must be interrelated to and affect each other. Random unknown variables would not necessarily converge because random unknown variables may or may not influence each other. For example, a more accurate viscosity measurement would improve a frequency of oscillation measurement or estimation. However, a more accurate viscosity measurement would not necessarily improve a boiling point measurement or estimation. As such, the unknown variables of the present invention must be interrelated to remain compatible for the converging solution of the iterative process.

The present invention selects for an m flow meter taking an n measurement because of the resulting compatible equation, which is interactive with the other flow meters and their respective compatible equation. The entire system of flow meters works as a whole with inter-dependent meters, unlike prior art systems with multiple meters and merely compiled results. Accordingly for iterative mathematical solutions, the number of equations of the mathematical model corresponds to a number of interrelated unknown variables of the n groups of interrelated unknown variables in embodiments of the present invention. The selection of an m flow meter is further determined by the interrelatedness of the n groups of interrelated unknown variables. The compatibility with a converging solution of the iterative process further defines the unknown variables and proper flow meter for the system.

In alternate embodiments, the present invention can select for a number of n measurements in addition to the number of m flow meters because the n measurements also correspond to the number of interrelated unknown variables of the n groups of interrelated unknown variables. A single flow meter can take more than one measurement, and each measurement of the single flow meter can correspond to a respective group of interrelated unknown variables and a respective equation of the mathematical model. A single flow meter can be responsible for contributing more than one equation of the mathematical model for the iterative process. For example, a first flow meter can have an oscillating element inserted in the multi-phase fluid, the first flow meter taking a first measurement based on the set of parameters, and the first measurement corresponding to a first group of interrelated unknown variables. The first flow meter can also take a second measurement based on the set of parameters, the second measurement corresponding to a second group of interrelated unknown variables. In some cases, the first flow meter may also take a third measurement based on the set of parameters, the third measurement corresponding to a third group of interrelated unknown variables. The first, second, and third measurements of the first flow meter determine three different groups of interrelated unknown variables, so that three equations can be contributed to the mathematical model for solution of the target unknown variable. The subsequent flow meters in the system of the present invention are selected to be compatible with this first flow meter. The subsequent flow meter must take a subsequent measurement that corresponds to a subsequent group of interrelated unknown variables, different than the first three groups already in the system. Not just any subsequent flow meter will be compatible in the present invention.

In other alternate embodiments, the present invention can select for a number of m flow meters. Instead of relying upon a single flow meter to take more than one measurement, an additional flow meter can be used to add an additional n measurement, an additional group of interrelated unknown variables, and an additional equation to the mathematical model of the iterative process. For example, a first flow meter can have an oscillating element inserted in the multi-phase fluid, the first flow meter taking a first measurement based on the set of parameters, and the first measurement corresponding to a first group of interrelated unknown variables. Then, a second flow meter can take a second measurement based on the set of parameters, the second measurement corresponding to a second group of interrelated unknown variables. In some cases, a third flow meter may also take a third measurement based on the set of parameters, the third measurement corresponding to a third group of interrelated unknown variables. The first, second, and third measurements of the first, second, and third flow meters determine three different groups of interrelated unknown variables, so that three equations can be contributed to the mathematical model for solution of the target unknown variable. The subsequent flow meters in the system of the present invention are selected to be compatible with the first, second, and third flow meters. That fourth flow meter must take a fourth measurement that corresponds to a fourth group of interrelated unknown variables, different than the first three groups already in the system. Not just any fourth flow meter will be compatible in the present invention.

The type and sensitivity of a flow meter are also relevant to embodiments of the present invention. Each type of flow meter measures differently. In embodiment of the present invention and claims, the term “flow meter” is used to define a meter placed along the flow of the multiphase fluid. As such, each flow meter takes measurements related to aspects and characteristics of flow or measurements that could be affected by flow. A water cut meter, a Coriolis meter, and a venturi meter can all be flow meters in the present system as described and claimed, even though the venturi meter, out of the three listed meters, is the only device directly measuring an aspect or features of actual flow. As long as a measuring device is placed along the flow of the multiphase fluid, that device is a flow meter for the present invention.

A venturi meter relies on different physical principles and measuring mechanics than a Coriolis meter, which differs from a water cut meter, and which also differs from a straight pipe pressure sensor. Other types of flow meters would have their own mechanics of measuring as well. A venturi meter has a different sensitivity to changes in cross-section of flow than a Coriolis meter, which differs from a water cut meter, and which also differs from a straight pipe pressure sensor. Another brand of venturi meter or placement of a venturi meter in a different part of the flow of the multiphase fluid would have a different sensitivity to cross-section or other measured variable as well. The present invention utilizes these differences in type and sensitivity to form the claimed system of flow meters and a processor. The system can include a Coriolis meter and a water cut meter, when the Coriolis measurement and the water cut measurement correspond to different groups of interrelated unknown variables and a different equation to contribute to the mathematical iterative process. The system can include a first venturi meter and a second venturi meter, when the first venturi measurement and the second venturi measurement correspond to different groups of interrelated unknown variables and a different equation to contribute to the mathematical iterative process. The first venturi meter has a first sensitivity to a measured variable, the first measurement and the first group of interrelated unknown variables being affected by the measured variable. The second venturi meter has a second sensitivity to the measured variable, the second measurement and the second group of interrelated unknown variables being affected differently by the measured variable. The equations corresponding to these first and second groups of interrelated unknown variables can be compatible with the iterative process.

The embodiments of the present invention also include a system with a temperature sensor, a pressure sensor, or both. These sensors can be placed along the flow of the multiphase fluid as well. The measurements taken from these sensors can contribute to the mathematical model and iterative solution of the present invention as well. These sensors do not necessarily contribute additional equations for more interrelated unknown variables, so even though these devices take measurements along the flow of the multiphase fluid, these sensors are not necessarily flow meters for purposes of the overall system.

Embodiments of the present invention also include a method for estimating a target unknown variable of a multiphase fluid. One embodiment of the method includes installing an m number of flow meters along a fluid flow of the multiphase fluid, wherein m is a positive integer, and wherein n is a positive integer. There are n measurements taken by the flow meters based on a set of parameters of the multiphase fluid, each of n measurements corresponding to a respective n groups of interrelated unknown variables. The interrelated unknown variables are selected from the set of parameters, and the n groups of interrelated unknown variables are different from each other. The n groups of variables can be different in number, identity, both or other grounds to result in a different equation to contribute to the system. Next, a mathematical model compatible with an iterative process is determined. The mathematical model is comprised of equations corresponding to each of the n measurements of the m flow meters. The n groups of interrelated unknown variables are different from each other in the equations based on the n measurements; as such, the equations are different from each other. Then, the method of the present invention solves the equations with the iterative process for a more accurate and precise value of the target unknown variable.

In embodiments of the method, each group of interrelated unknown variables is different, and the target unknown variable is selected from an unknown variable of the n groups of interrelated unknown variables corresponding to the n measurements. Each group of interrelated unknown variables is different, in terms of number of interrelated unknown variables, identity of interrelated unknown variables, both number and identity or other grounds to result in a contribution to the iterative mathematical model. The target unknown variable can be solved by the selected measurements because the target unknown variable is selected from the group of interrelated unknown variables. Thus, the method can also include selecting a number of equations of the mathematical model so as to correspond to a number of interrelated unknown variables of the n groups of interrelated unknown variables, according to compatibility with the iterative process. This number of equations is determined by a number of measurements from the m flow meters, a number of the m flow meters, or both.

In alternative embodiments, the method further comprises selecting a flow meter to be one of the m flow meters according to type of flow meter, according to sensitivity to a measured variable, or both. The type of flow meter corresponds to a respective measurement by the flow meter, a respective group of interrelated unknown variables, and respective equation so as to be a contribution to the mathematical model of the present invention. The sensitivity to a measured variable also corresponds to a respective measurement by the flow meter, a respective group of interrelated unknown variables, and respective equation so as to be compatible with the mathematical model and the iterative process.

The embodiments of the present invention move beyond the prior art disclosure of multiple flow meters in a fluid flow because the whole system is interactive. The data and calculations from more than one flow meter are not merely compiled and related for the system of two flow meters, which adapts the math according to the flow meter added into the system. The equations from the selected flow meters must contribute unknown variables that are interrelated. The embodiments of the present invention disclose a system and method of selected numbers and types of flow meters contributing to an iterative mathematical model for the estimation of a target unknown, unlike the prior art systems with adjusted math and assumed unknown variables.

In a particular embodiment of the invention, the system described herein measures the bulk density and flow of a multi-phase flow stream in real-time. Bulk density and fluid flow are measurements, with corresponding equations to contribute to the iterative mathematical model. Slip is an unknown variable in the set of parameters, and both bulk density and fluid flow utilize simultaneous equations to correct for the slip, which is common in both the density and fluid flow equations related to the respective measurements. As discussed, the system may utilize another independent flow meter to increase the number of equations to allow for the use of a wider band of flow conditions, i.e. more parameters, more unknown variables, more equations with slip. Additional measurements can include measurements of power, viscosity etc. to increase the number of simultaneous equations, and hence the accuracy of the multi-phase flow calculations.

FIG. 1g is a schematic diagram of a multi-phase flow measuring system 100 according to one embodiment of the disclosure. The system 100 is shown to include a Coriolis meter 110 to measure in-situ the density of the fluid 102 flowing through the meter 110 by measuring the natural frequency of oscillation of the tubes inside the meter 110. In this example, the power and frequency of the Coriolis driving circuit is measured to obtain two equations. In another aspect, the system 100 measures the Coriolis twist of the tubes 112, which twist is proportional to the mass flow rate through the tubes. Twist is a third measurement. The single flow meter 110 provides first, second, and third measurements, corresponding to respective equations related to the groups of unknown variables.

The equations describing the motion of the tubes 112 and the Coriolis twist that may be utilized are given below. Both the Coriolis twist and natural frequency are affected by the slip. The additional unknowns are the liquid and gas flow rates.

ω=f₁(ρ,Q_{G},Q_{O},Q_{W},S,μ,P,T) Eqn. 10

Twist=f₂(ρ,Q_{G},Q_{O},Q_{W},S,μ,P,T) Eqn. 11

Power=f₃(ρ,Q_{G},Q_{O},Q_{W},S,μ,P,T) Eqn. 12

The system described herein measures the bulk density. Bulk density is the first measurement. In the above equations, ρ is the density of the mixture, Q_{G} is the volumetric flow rate of the gas, Q_{O} is the volumetric flow rate of the oil, Q_{W} is the volumetric flow rate of the water, S is the slip ratio, and μ is the flow averaged viscosity of the liquid, P is the line pressure, and T is the line temperature.

Solving for six (6) unknowns with three (3) equations is not feasible. Therefore, three (3) additional equations are required. According to the iterative mathematical model of the present invention, the flow meter 110 provides first, second, and third measurements for three equations, and more equations are needed for the solution. To arrive at another equation for this additional unknown, the system 100 utilizes another meter, such as a venturi meter 120 shown in FIG. 1g. The pressure drop from the inlet of the venturi to the throat also depends on the slip, as given in the fourth equation below.

ΔPᵢₙₗₑₜ₋ₜₕᵣₒₐₜ=f₄(ρ,Q_{G},Q_{O},Q_{W},S,μ,P,T) Eqn. 13

The fifth equation may be obtained from a water-cut meter 140, which may be connected in tandem with the Coriolis and the venturi meter to measure the water cut and thus compute the oil, water and gas flow rates. Any suitable water cut meter may be used, including one sold by Agar Corporation. The Agar water-cut meter measures the complex dielectric of the fluid and uses the Bruggeman's equation to determine the concentrations of oil and water in the liquid.

∈=f₅(ρ,Q_{G},Q_{O},Q_{W},S,μ,P,T) Eqn. 14

As noted earlier, variation in viscosity (μ) influences slip (S), among other variables, and can contribute significantly to the errors in flow measurement. Therefore, it is desirable to have a sixth equation if the viscosity is changing significantly. Employing another equation means one extra measurement needs to be made. In one aspect, the system may measure viscosity by measuring the pressure-drop across a short straight section of the piping 130, and uses this measurement to compensate for the errors introduced due to varying viscosity.

ΔP_{straightpipe}=f₆(ρ,Q_{G},Q_{O},Q_{W},S,μ,P,T) Eqn. 15

The line pressure P and temperature T measurements to convert the flow rates measured at line conditions to those at standard conditions may be obtained from a pressure sensor 150 and a temperature sensor 160 in the flow line 170. In this one embodiment of the present invention, there are three flow meters, taking six measurements related to the set of parameters. Each of the six measurement correspond to six groups of unknown variables and six equations with those unknown variables. The above system of nonlinear simultaneous equations may be written in the form of a non algebraic matrix, for the sake of ease of presentation, as shown below.

$$\{ \begin{matrix}ω \\ Twist \\ Power \\ Δ {P}_{inlet - throat} \\ ɛ \\ Δ {P}_{straight pipe}\end{matrix} \} = [ \begin{matrix}{A}_{11} & {A}_{12} & {A}_{13} & {A}_{14} & {A}_{15} & {A}_{16} \\ {A}_{21} & {A}_{22} & {A}_{23} & {A}_{24} & {A}_{25} & {A}_{26} \\ {A}_{31} & {A}_{32} & {A}_{33} & {A}_{34} & {A}_{35} & {A}_{36} \\ {A}_{41} & {A}_{42} & {A}_{43} & {A}_{44} & {A}_{45} & {A}_{56} \\ {A}_{51} & {A}_{52} & {A}_{53} & {A}_{54} & {A}_{55} & {A}_{56} \\ {A}_{61} & {A}_{62} & {A}_{63} & {A}_{64} & {A}_{65} & {A}_{66}\end{matrix} ] \cdot \{ \begin{matrix}ρ \\ {Q}_{G} \\ {Q}_{O} \\ {Q}_{W} \\ S \\ μ\end{matrix} \} \qquad Eqn . 16$$

As the equations are non-linear, the elements of non-algebraic matrix A are not constant. For example, in the case of a single-phase flow of only water, i.e. no oil and no gas, the equation for ΔPᵢₙₗₑₜ_{_{—}}_{throaght} is:

$$Δ {P}_{inlet - throat} = \frac{1}{2} \frac{{ρ}_{W} {Q}_{W}^{2}}{{A}_{inlet}^{2} {C}_{d}^{2}} ( \frac{1}{{β}^{4}} - 1 ) \qquad Eqn . 17$$

In the above equation, ρ_{w}, is the density of water, Q_{W}, is the volumetric flow rate of water, Aᵢₙₗₑₜ is the area of inlet of the venturi meter, β is the ratio of the throat diameter to the inlet diameter of the venturi, and C_{d} is the coefficient of discharge. This equation has Q_{W} one of the unknown variables, and other unknown variables that are not common with the other five equations, and this equation can still contribute to the iterative solution to solve for a target unknown variable, which is selected from the common unknown variables of the six equations.

Therefore, element A₄₄ is

$${A}_{44} = \frac{1}{2} \frac{{ρ}_{W} {Q}_{W}}{{A}_{inlet}^{2} {C}_{d}^{2}} ( \frac{1}{{β}^{4}} - 1 ) \qquad Eqn . 18$$

Thus, it can be seen that A₄₄ depends on the variable Q_{W} which is one of the unknown variables. The metering system then may utilize an iterative method to solve such a system of equations, represented by equations 10-15.

In another illustrative example and referring to FIG. 1 e, wherein oil (no water, no air, and no solids) of unknown density and unknown viscosity is flowing at an unknown flow rate. Thus, the unknowns are density, viscosity, and flow rate of oil. It can be seen that the subcomponents of the example meter are 1) vibrating density meter, 2) Venturi and 3) Straight pipe section over which the differential pressure is measured. Each of the sub-components results in an equation. Since there are three sub-components with three measurements, there are three equations. Note that the number of unknowns is also three. At a first level of approximation, the following equations describe the flow:

$$\begin{matrix}i . Δ {P}_{Straight - Pipe} = \frac{128 μ L {Q}_{O}}{π {D}^{4}} \\ ii . Δ {P}_{Inlet - Throat} = \frac{1}{2 {( \frac{π {D}^{2}}{4} )}^{2} {C}_{d}^{2}} ρ {Q}_{O}^{2} ( \frac{1}{{β}^{4}} - 1 ) \\ iii . ω = \sqrt{\frac{K}{{ρ}_{t} + ρ}}\end{matrix}$$

In the above equations, μ is the viscosity of the oil, L is the length of the straight pipe, Q_{O} is the volumetric flow rate of the oil, D is the diameter of the straight pipe, C_{d} is the discharge coefficient of the Venturi, β is the ratio of the throat diameter to the inlet diameter of the Venturi, ω is the frequency of oscillation measured by the vibrating density meter, K is the stiffness and ρₜ is the tube density term (which are constants).
It can be seen from equation i that, to a first degree of approximation, ΔP_{Straight-Pipe} varies linearly with Q_{O} and μ and does not depend on ρ. Similarly, from equation ii, ΔP_{Inlet-Throat} varies linearly with Δ, quadratically with Q_{O} and does not depend on μ and from equation iii, ω, to a first degree of approximation, does not depend on μ and Q_{O} and varies as ρ^{-0.5}. Thus it can be seen that each of the measured variables is affected by the unknown variables ρ, Q_{O}, and μ to a different sensitivity and therefore the successive iterations of the system of equations will converge. It can also be seen that even for the above simplified example, the equations are non-linear. The above equations i, ii, and iii can be expressed in a form similar to eqns. 10-15 as follows:

$$\begin{matrix} iv . ω = \sqrt{\frac{K}{{ρ}_{t} + ρ}} + 0. {Q}_{G} + 0. {Q}_{O} + 0. {Q}_{W} + 0. S + 0. μ \\ v . Δ {P}_{Inlet - Throat} = \frac{1}{2 {( \frac{π {D}^{2}}{4} )}^{2} {C}_{d}^{2}} ρ {Q}_{O}^{2} ( \frac{1}{{β}^{4}} - 1 ) + 0. {Q}_{G} + 0. {Q}_{W} + 0. S + 0. μ \\ vi . Δ {P}_{Straight - Pipe} = \frac{128 μ L {Q}_{O}}{π {D}^{4}} + 0. ρ + 0. {Q}_{G} + 0. {Q}_{W} + 0. S\end{matrix}$$

Note that the above equations where correct to only a first degree of approximation. One can always increase the accuracy, by writing the equations to a higher degree of approximation, adding additional variables, including variables specific to the equation and unrelated to the group of unknown variables for the iterative mathematical model of the present invention. For example, the equations to a second degree of approximation are:

$$\begin{matrix}vii . ω = \sqrt{\frac{K}{{m}_{t} + ρ} - {( \frac{{C}_{1} μ + {C}_{2} {Q}_{O}}{{m}_{t} + ρ} )}^{2}} \\ viii . Δ {P}_{Straight - Pipe} = f \frac{L}{D} \frac{1}{2} ρ \frac{{Q}_{O}^{2}}{{( \frac{π}{4} {D}^{2} )}^{2}} \\ ix . Δ {P}_{Inlet - Throat} = \frac{1}{2 {( \frac{π {D}^{2}}{4} )}^{2} {C}_{d}^{2}} ρ {Q}_{O}^{2} ( \frac{1}{{β}^{4}} - 1 )\end{matrix}$$

In the above equation, C₁ and C₂ are constants and it can be seen that ω now depends weakly on p and Q_{O}. In equation viii, f is the friction factor and depending on the whether the flow is laminar or turbulent, the ΔP_{Straight-Pipe} is either independent of ω or weakly dependent on ω. It can be seen that even taking higher order effects into account, the requirement that the sensitivity of the various components to the unknown variables be different is maintained and thus the system of equations will converge. The above equations vii, viii, and ix can be expressed in a form similar to eqns. 10-15 as follows:

$$\begin{matrix} x . ω = \sqrt{\frac{K}{{m}_{t} + ρ} - {( \frac{{C}_{1} μ + {C}_{2} {Q}_{O}}{{m}_{t} + ρ} )}^{2}} + 0. {Q}_{G} + 0. {Q}_{W} + 0. S \\ xi . Δ {P}_{Inlet - Throat} = \frac{1}{2 {( \frac{π {D}^{2}}{4} )}^{2} {C}_{d}^{2}} ρ {Q}_{O}^{2} ( \frac{1}{{β}^{4}} - 1 ) + 0. {Q}_{G} + 0. {Q}_{W} + 0. S + 0. μ \\ xii . Δ {P}_{Straight - Pipe} = f \frac{L}{D} \frac{1}{2} ρ \frac{{Q}_{O}^{2}}{{( \frac{π}{4} {D}^{2} )}^{2}} + 0. {Q}_{G} + 0. {Q}_{W} + 0. S\end{matrix}$$

The complexity of the problem can be increased by looking at the case where in addition to oil flow rate, there is water flow rate; still no gas flow or solid flow. Thus the unknowns now are density (ρ) and viscosity (μ) of the oil-water mixture, flow rate of oil (Q_{O}) and flow rate of water (Q_{W}). As the number of unknowns has now been increased to four, the number of equations also needs to be increased; and an additional sub-component is added in tandem, viz. the water-cut meter as shown in FIG. 1f, which provides the extra equation. Thus the system of equations now is

$$\begin{matrix} x . ω = \sqrt{\frac{K}{{m}_{t} + ρ} - {( \frac{{C}_{1} μ + {C}_{2} {Q}_{O}}{{m}_{t} + ρ} )}^{2}} + 0. {Q}_{G} + 0. {Q}_{W} + 0. S \\ xi . Δ {P}_{Inlet - Throat} = \frac{1}{2 {( \frac{π {D}^{2}}{4} )}^{2} {C}_{d}^{2}} ρ {Q}_{O}^{2} ( \frac{1}{{β}^{4}} - 1 ) + 0. {Q}_{G} + 0. {Q}_{W} + 0. S + 0. μ \\ xii . Δ {P}_{Straight - Pipe} = f \frac{L}{D} \frac{1}{2} ρ \frac{{Q}_{O}^{2}}{{( \frac{π}{4} {D}^{2} )}^{2}} + 0. {Q}_{G} + 0. {Q}_{W} + 0. S \\ xiii . 1 - \frac{{Q}_{W}}{{Q}_{W} + {Q}_{O}} = \frac{{ɛ}_{W} - {ɛ}_{mixture}}{{ɛ}_{W} - {ɛ}_{O}} {( \frac{{ɛ}_{O}}{{ɛ}_{mixture}} )}^{\frac{1}{3}} + 0. ρ + 0. {Q}_{G} + 0. μ + 0. S\end{matrix}$$

The addition of the water-cut meter yields an extra equation xiii which depends on the unknowns in a different way compared to equations x, xi, and xii. Hence the system of equations x, xi, xii, and xiii can be solved for the unknowns ρ, μ, Q_{O}, and Q_{W}.

It can thus be seen that the essence of invention is that different sub-components of the meter are chosen such that the resulting equations have different sensitivity to the unknowns. An iterative procedure is used to solve the system of equations; note that the requirement of the equations having different sensitivity to the unknowns ensures that the successive iterations converge. Also, the more the number of unknowns the more the number of equations needed, hence the more the number of sub-components. FIG. 1g describes an embodiment that identifies the individual components and subsections for three flow meters with six measurements, and six equations. As the number of unknowns in the flow, e.g., slip, viscosity, etc. increases so also the number of independent equations increases, and hence the number of independent measurements increases. By adjusting and arranging a number of instruments, accurate equations (mathematical models as opposed to empirical models) may be built according to one aspect of the disclosure. More accurate results may be obtained by adjusting the gain and zero of the measuring devices to yield the same common result, as described above. A simplified relationship that may be used to describe the apparatus and methods described herein may be expressed as:

Flow Apparatus→Vibrating Density Meter+Flow Meter₁+Flow Meter₂+Water Concentration Meter

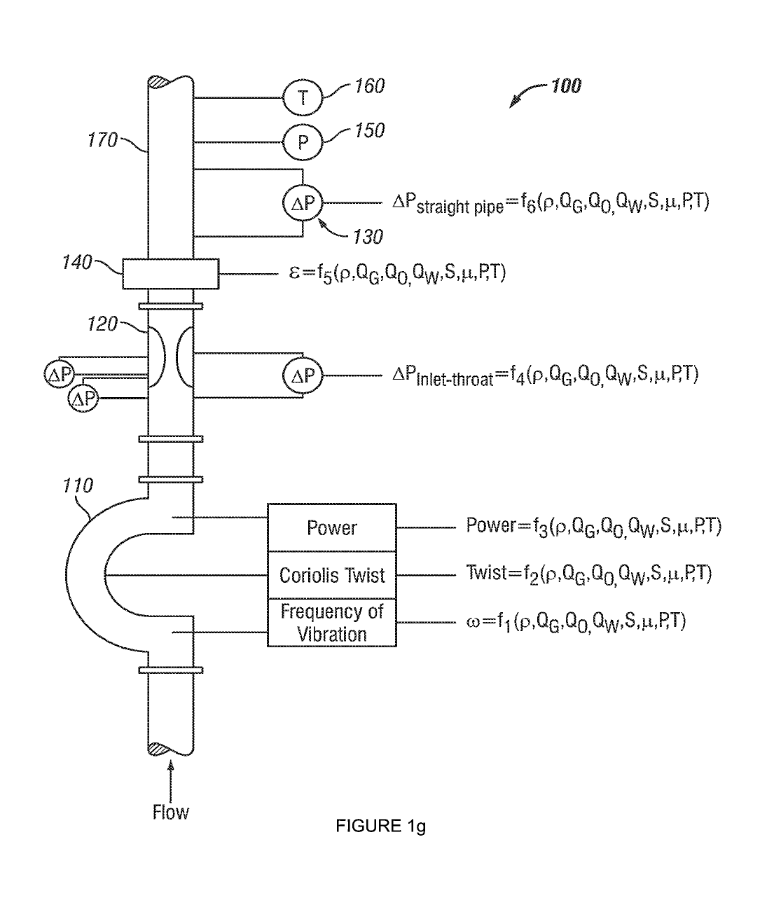

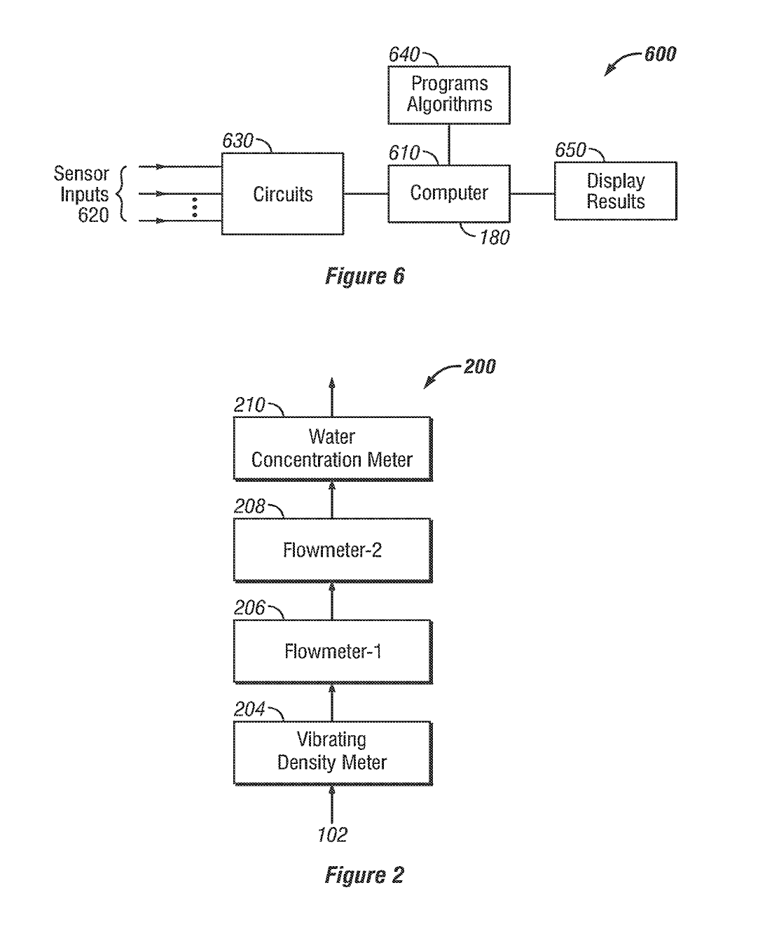

FIG. 2 is a flow diagram illustrating the above shown scheme for determining the flow rate of a multi-phase fluid, i.e., a vibrating density meter 204, a first flow meter 206, a second flow meter 208 and a water concentration meter 210.

The example given in reference to FIG. 1g corresponds to an embodiment that utilizes frequency from the Coriolis meter as a density measurement, Coriolis twist for the first flow measurement, and pressure drop from the inlet to throat of the venturi for the second flow measurement.

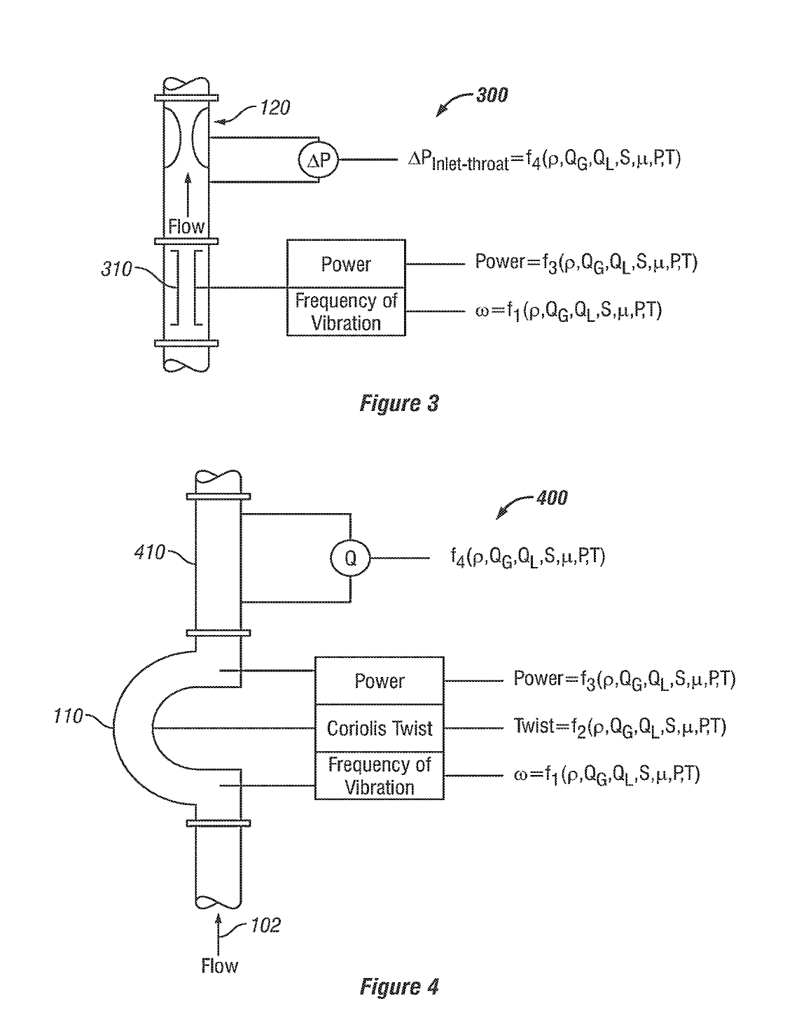

FIG. 3 is a schematic diagram of an apparatus 300 for determining density by a density meter, such as a vibrating fork, tubes and cylinders, floats and the like. The density meter 310 may be coupled to the venturi meter 120 in the system for determining the flow of a multi-phase fluid flow.

FIG. 4 is a schematic diagram of an apparatus 400 showing an alternative flow meter 410, such as an orifice plates, inverted cones, turbine flow meter, ultrasonic flow meter, positive displacement meter, and the like instead of the venturi meter 120 shown in FIG. 1.

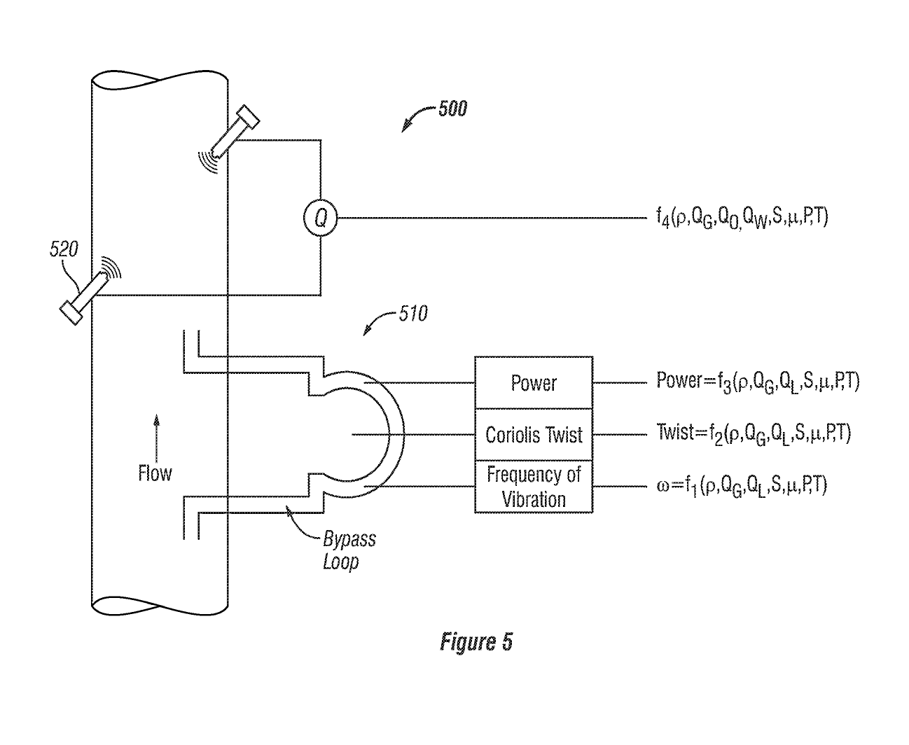

In some cases, use of a large density meter in tandem with a flow meter may not be practical. FIG. 5 is a schematic diagram of an alternative embodiment of an apparatus 500 for measuring the flow rate. FIG. 5 shows a Coriolis Meter connected in a slip stream and is used to measure a portion of the mass flow, yet has the same fluid composition as the fluid in the main line. The fraction of the fluid in the bypass is predetermined, but is not critical as it exhibits only a small portion of the total flow which is measured by the flow meter 510.

FIG. 6 shows a computer system 600 that includes a computer or processor 610. Outputs 620 from the various sensors in the system of FIG. 1g (and the alternative embodiment shown in FIGS. 2-5) are fed to a data acquisition circuit 630 in the system of FIG. 6, which circuit is configured to output sensor information to the computer 610. The computer processes such information using the programs and algorithms and other information 640 stored in its memory, collectively denoted by 640, and provides on line (in-situ) the calculated results relating to the various parameters described herein and the fluid flow results of the multi-phase fluid 102. The equations described herein and the data used by the computer 610 may be stored in a memory in the computer or another storage device accessible to the computer. The results may be displayed on a display 650 device (such as a monitor) and/or provided in another medium of expression, such as hard copies, tapes, etc.

Thus, in one embodiment of the present invention, the system for measuring flow of a multi-phase fluid includes a flow meter with a vibrating element inserted in the measured fluid, in conjunction with one or two different types of flow meters and a computer suitable to solve non-linear simultaneous equations, a driver circuit to vibrate the vibrating element in its natural frequency of oscillation, a data collection circuit for measuring, power, frequency, pressure, temperature and other process related signals, effected by the flow of multi-phase fluid. The fluid may include gas, oil and/or water. The fluid may also include solids.

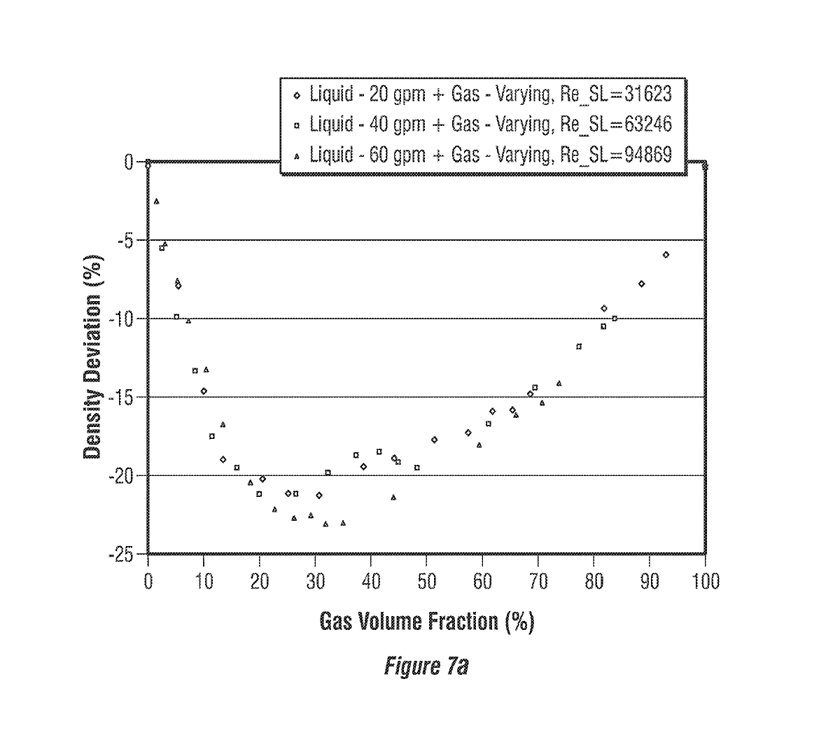

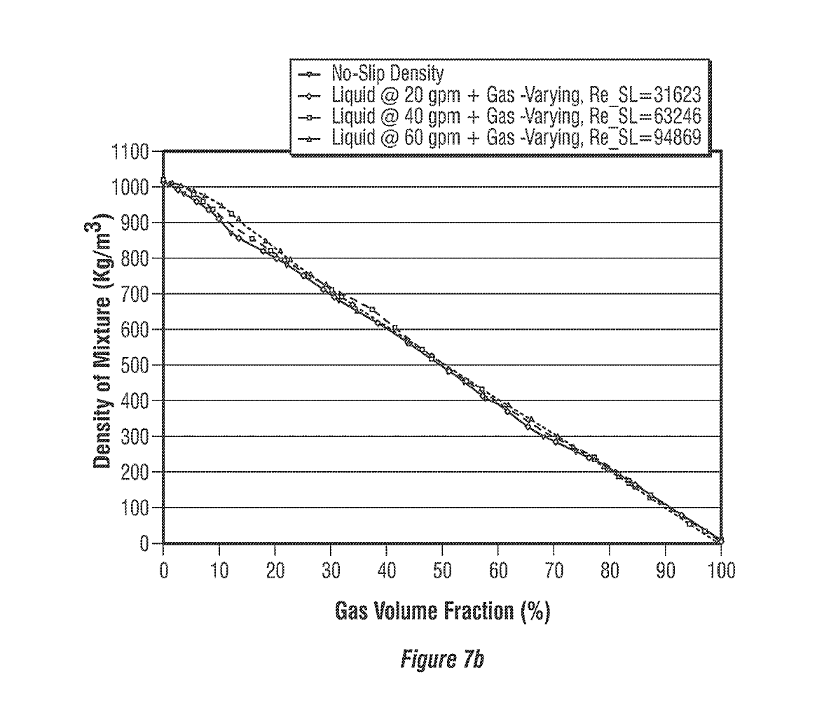

The results obtained using the above described methods are described in reference to FIG. 7a. The density deviation, defined below, as the amount of gas, or Gas Volume Fraction, GVF, is increased.

$$\begin{matrix}DensityDeviation = \frac{MeasuredBulkDensity - BulkDensityAssumingNoSlip}{LiquidDensity} & Eqn . 19 \\ GasVolumeFraction = \frac{VolumeOfGas}{VolumeOfGas + VolumeOfLiquid} & Eqn . 20\end{matrix}$$

FIG. 7b show the mixture bulk density, after correcting for the effect of slip, using equations 10 and 12. Further improvements in density correction may be made by using all of the equations 10-15. It can be seen that, the current method measures bulk density quite accurately in the full gas volume fraction range, i.e. 0≦GVF≦100%. Prior art methods typically measure the density accurately in the general range from 0≦GVF≦55%.

A data acquisition circuit may collect data from various sensors as inputs, such as frequency of oscillation, angle of twist, drive power consumption, pressure, temperature, differential pressure, complex dielectric, sound ways, torque, etc. A computer may be configured to solve non-linear simultaneous equations using the values of parameters calculated from the various sensors. For example, the computer may be configured to output the slip-corrected total mass flow rate as the target unknown variable based on the inputs from the data acquisition circuit. Alternatively, the computer may be configured to output the slip and viscosity-corrected total mass flow rate as the target unknown variable based on the inputs from the data acquisition circuit. The computer may be configured to output the corrected mass or volume flow of the flowing gas and liquid. In yet another aspect, the computer may be configured to output the corrected mass or volume flow of the flowing gas, oil and water. The computer is operable to output the corrected mass or volume flow of the flowing gas, oil, water and solids as the target unknown variable. In another aspect, the pressure drop across a straight pipe or the pressure drop from flange to flange of a venturi tube may be utilized to compute viscous losses.

In the prior art, it is easy enough to write down equations which govern the multiphase flow problem. These equations, as mathematical models or sets of equations, can be solved and estimated in different ways and to different degrees of accuracy. The rigorous mathematical solution requires that various parameters and their interrelationships be known. For example, there is no universal mathematical equation describing how interfacial tension affects the flow patterns, which is valid for all viscosities, flow rates, line pressures, temperatures, fluid component pairs (e.g. low viscosity oil and air, water and air, high viscosity oil and natural gas) etc. In the prior art, estimations or correlations were relied upon for solving the equations and approximating such complex values. The invention presents an innovation beyond these prior art solutions and drawbacks, wherein flow meters and measurements are selected for forming a mathematical model of converging equations. Approximated values are no longer required because real time data and calculations can complete more and more accurate solutions of the complex equations for the target unknown variable. In the case of interfacial tension and flow patterns, equations of the present invention can more accurately and precisely account the viscosities, flow rates, fluid component pairs, or other related variables.

While the foregoing disclosure is directed to certain embodiments, various changes and modifications to such embodiments will be apparent to those skilled in the art. It is intended that all changes and modifications that are within the scope and spirit of the appended claims be embraced by the disclosure herein.

We claim:

1. A flow meter system comprising:
an m number of flow meters taking n measurements based on a set of parameters of said multiphase fluid, each of n measurements corresponding to a respective n groups of interrelated unknown variables,
wherein m is a positive integer,
wherein n is a positive integer,
wherein said interrelated unknown variables are selected from said set of parameters, and
wherein the n groups of interrelated unknown variables are different from each other; and
a processor to solve equations of a mathematical model so as to estimate an amount of a target unknown variable selected from said set of parameters, wherein the n measurements of said m flow meters determine said equations of said mathematical model, wherein said equations each correspond to the n groups of interrelated unknown variables, and wherein an iterative process is used to solve said equations.

2. The flow meter system, according to claim 1, wherein each group of interrelated unknown variables is different, wherein said target unknown variable is selected from an unknown variable of the n groups of interrelated unknown variables corresponding to the n measurements, and wherein said iterative process solves for said target unknown variable.

3. The flow meter system, according to claim 1, wherein a number of equations of said mathematical model corresponds to a number of interrelated unknown variables of the n groups of interrelated unknown variables, according to compatibility with said iterative process.

4. The flow meter system, according to claim 1, wherein a number of measurements from said m flow meters corresponds to said number of interrelated unknown variables of the n groups of interrelated unknown variables, according to compatibility with said iterative process.

5. The flow meter system, according to claim 4, wherein a single flow meter takes more than one measurement, each measurement of said single flow meter corresponding to a respective group of interrelated unknown variables and a respective equation of said mathematical model.

6. The flow meter system, according to claim 5, wherein a first flow meter has an oscillating element inserted in said multi-phase fluid, said first flow meter taking a first measurement based on said set of parameters, said first measurement corresponding to a first group of interrelated unknown variables,
wherein said first flow meter takes a second measurement based on said set of parameters, said second measurement corresponding to a second group of interrelated unknown variables.

7. The flow meter system, according to claim 6, wherein said first flow meter takes a third measurement based on said set of parameters, said third measurement corresponding to a third group of interrelated unknown variables.

8. The flow meter system, according to claim 1, wherein a number of said m flow meters corresponds to said number of interrelated unknown variables of the n groups of interrelated unknown variables, according to compatibility with said iterative process.

9. The flow meter system, according to claim 8, wherein a first flow meter has an oscillating element inserted in said multi-phase fluid, said first flow meter taking a first measurement based on said set of parameters, said first measurement corresponding to a first group of interrelated unknown variables,
wherein a second meter takes a second measurement based on said set of parameters, said second measurement corresponding to a second group of interrelated unknown variables.

10. The flow meter system, according to claim 9, wherein a third meter takes a third measurement based on said set of parameters, said third measurement corresponding to a third group of interrelated unknown variables.

11. The flow meter system, according to claim 1, wherein a type of flow meter of each of said m flow meters corresponds to a number of interrelated unknown variables of the n groups of interrelated unknown variables, according to compatibility with said iterative process.

12. The flow meter system, according to claim 11, wherein a first flow meter has an oscillating element inserted in said multi-phase fluid, said first flow meter taking a first measurement based on said set of parameters, said first measurement corresponding to a first group of interrelated unknown variables,
wherein said first flow meter is a Coriolis meter, and
wherein a second flow meter is selected from a group consisting of: a venturi meter, Coriolis meter, a water cut meter, and a straight pipe pressure sensor.

13. The flow meter system, according to claim 1, wherein a sensitivity to a measured variable of each of the m flow meters corresponds to a number of interrelated unknown variables of the n groups of interrelated unknown variables, according to compatibility with said iterative process.

14. The flow meter system, according to claim 13, wherein a first flow meter takes a first measurement based on said set of parameters, said first measurement corresponding to a first group of interrelated unknown variables,
wherein said first flow meter has a first sensitivity to said measured variable, said first measurement and said first group of interrelated unknown variables being affected by said measured variable,
wherein a second flow meter has a second sensitivity to said measured variable, said second measurement and said second group of interrelated unknown variables being affected differently by said measured variable, and wherein said equations corresponding to the first and second group of interrelated unknown variables are compatible with said iterative process.

15. A method for estimating a target unknown variable of a multiphase fluid, the method comprising the steps of:
installing an m number of flow meters along a fluid flow of said multiphase fluid, wherein m is a positive integer;
taking n measurements based on a set of parameters of said multiphase fluid, each of n measurements corresponding to a respective n groups of interrelated unknown variables, wherein said interrelated unknown variables are selected from said set of parameters, wherein n is a positive integer, and wherein the n groups of interrelated unknown variables are different from each other;
determining a mathematical model compatible with an iterative process, said mathematical model being comprised of equations corresponding to each of the n measurements of said m flow meters, wherein the n groups of interrelated unknown variables are different from each other in said equations based on the n measurements, wherein said equations are different from each other; and
solving said equations with said iterative process.

16. The method for estimating, according to claim 15, wherein each group of interrelated unknown variables is different, wherein said target unknown variable is selected from an unknown variable of the n groups of interrelated unknown variables corresponding to the n measurements, and wherein said iterative process solves for said target unknown variable.

17. The method for estimating, according to claim 15, further comprising the step of:
selecting a number of equations of said mathematical model so as to correspond to a number of interrelated unknown variables of the n groups of interrelated unknown variables, according to compatibility with said iterative process.

18. The method for estimating, according to claim 17, wherein the step of selecting said number of equations is determined by a number of measurements from said m flow meters, a number of said m flow meters, or both.

19. The method for estimating, according to claim 17, further comprising the step of:
selecting a flow meter to be one of said m flow meters according to type of flow meter, said type of flow meter corresponding to a respective measurement by said flow meter, a respective group of interrelated unknown variables, and respective equation so as to be compatible with said mathematical model and said iterative process.

20. The method for estimating, according to claim 17, further comprising the step of:
selecting a flow meter to be one of said m flow meters according to sensitivity to a measured variable, said sensitivity to a measured variable corresponding to a respective measurement by said flow meter, a respective group of interrelated unknown variables, and respective equation so as to be compatible with said mathematical model and said iterative process.
